(19) United States
(12) Patent Application Publication
(10) Pub. No.: US 2015/0264225 A1
(43) Pub. Date: Sep. 17, 2015

(54) Camera grip with removable expansion module

(71) Applicant: Jeffrey Overall, Fountain Valley, CA (US)

(72) Inventor: Jeffrey Overall, Fountain Valley, CA (US)

(21) Appl. No.: 14/545,344

(22) Filed: Apr. 24, 2015

(51) Int. Cl. H04N 5/225; G03B 17/56

(52) U.S. Cl. CPC H04N 5/2251; G03B 17/561; G03B 17/566; G03B 17/563

(57) ABSTRACT

The present invention is generally related to the combination of various devices or elements and cameras. It is more specifically related to a camera grip with one or more removable expansion modules. In one aspect, the present invention provides a camera module. The module includes a camera module back, a rail, and a camera mount. The back and rail are capable of holding a camera add-on within the module. Camera attachment tabs allowing connection of the module to a camera grip are attached to the back.

### FIELD OF THE INVENTION

The present invention is generally related to the combination of various devices or elements and cameras. It is more specifically related to a camera grip with one or more removable expansion modules.

### BACKGROUND OF THE INVENTION

There have been reports regarding the development of camera grips. For instance U.S. Pat. No. 8,628,257, entitled “Image-Pickup Apparatus Camera Grip, And Image-Pickup System” is allegedly directed to the following: “An image-pickup system includes an image-pickup apparatus having a first connection member and a camera grip having a second connection member capable of being attached to and removed from the first connection member. The first connection member includes a first screw member having a male screw and a first engagement member disposed inside the first screw member having a first concavo-convex shape. The second connection member includes a second screw member having a female screw part capable of engaging with the male screw part of the image-pickup apparatus and a second engagement member disposed inside the second screw member and having a second concavo-concave shape capable of engaging with the first concavo-concave shape of the image-pickup apparatus. The male screw part screws into the female screw part in a state where the first engagement member and the second engagement member engage with each other.” Abstract.

U.S. Pat. No. 7,280,151, entitled “Video Camera With A Rotatable Grip Unit” is allegedly directed to the following: “A video camera is disclosed which can make photographing without any compulsion. A rotary grip is provided on a side face of a camera body so as to be rotatable relative to the camera body, the camera body having an image pickup device, a camera lens and a circuit board of various circuits. A hand strap is attached to the rotary grip. For carrying the video camera, the fingers other than the thumb of one hand are inserted between the rotary grip and the hand strap so that the tips thereof are caught on a peripheral surface of the rotary grip. A liquid crystal display monitor and an operating unit are integral with the peripheral surface of the rotary grip, and when the rotary grip is rotated relative to the camera body unit, the hand strap, as well as the liquid crystal display monitor and the operating unit, also rotate. Thus, the direction of the liquid crystal display monitor and that of the operating unit can be changed with respect to a photographing direction, and it is also possible to change the way of carrying the video camera.” Abstract.

Despite the various reports, there is still a need in the art for new camera grips and various modifications.

### BRIEF DESCRIPTION OF THE DRAWINGS

FIG. 1 shows a front view of a camera grip having a receptacle for a camera module of the present invention.

FIG. 2 shows a front view of a camera module of the present invention, where the module is attached to a camera.

FIG. 3 shows a front view of a camera module of the present invention, where the module is attached to a camera grip and a camera.

FIG. 4 shows a back view of a camera grip having a receptacle for a camera module of the present invention.

FIG. 5 shows a back view of a camera module of the present invention, where the module is attached to a camera.

FIG. 6 shows a back view of a camera module of the present invention, where the module is attached to a camera grip and a camera.

FIG. 7 shows a side view of a camera grip having a receptacle for a camera module of the present invention.

FIG. 8 shows a side view of a camera module of the present invention, where the module is attached to a camera.

FIG. 9 shows a side view of a camera module of the present invention, where the module is attached to a camera grip and a camera.

FIG. 10 shows an end view of a camera module of the present invention.

FIG. 11 shows a front view of a camera module of the present invention.

FIG. 12 shows a back view of a camera module of the present invention.

FIG. 13 shows a front view of a camera module of the present invention, where the module has a tripod screw mount.

FIG. 14 shows a back view of a camera module of the present invention, where the module has a tripod screw mount.

FIG. 15 shows a front view of a camera module of the present invention, where there is an extension piece between the module and the camera mount.

FIG. 16 shows a back view of a camera module of the present invention, where there is an extension piece between the module and the camera mount.

### SUMMARY OF THE INVENTION

In one aspect, the present invention provides a camera module. The module includes a camera module back, a rail, and a camera mount. The back and rail are capable of holding a camera add-on within the module. Camera attachment tabs allowing connection of the module to a camera grip are attached to the back.

In another aspect, the present invention provides a method of increasing the effective screen size of a camera. The method comprises attaching a camera to a module that includes a second screen that is larger than the one on the camera itself. The module includes a camera module back, a rail, and a camera mount. The back and rail are capable of holding a camera add-on within the module. Camera attachment tabs allowing connection of the module to a camera grip are attached to the back.

In another aspect, the present invention provides a method of extending the battery life of a camera. The method comprises attaching a camera to a module that includes a battery pack and/or rechargeable battery. The module includes a camera module back, a rail, and a camera mount. The back and rail are capable of holding a camera add-on within the module. Camera attachment tabs allowing connection of the module to a camera grip are attached to the back.

In another aspect, the present invention provides a method of connecting remote control capability to a camera. The method comprises attaching a camera to a module that includes a remote control that can operate the camera. The module includes a camera module back, a rail, and a camera mount. The back and rail are capable of holding a camera add-on within the module. Camera attachment tabs allowing connection of the module to a camera grip are attached to the back.

In another aspect, the present invention provides a method of adding lighting capability to a camera. The method comprises attaching a camera to a module that includes one or more lights. The module includes a camera module back, a rail, and a camera mount. The back and rail are capable of holding a camera add-on within the module. Camera attachment tabs allowing connection of the module to a camera grip are attached to the back.

### DETAILED DESCRIPTION OF THE INVENTION

The present invention is generally related to the combination of various devices or elements and cameras. It is more specifically related to a camera grip with one or more removable expansion modules. The subject camera grips with removable expansion modules are discussed in detail in relation to the various figures below.

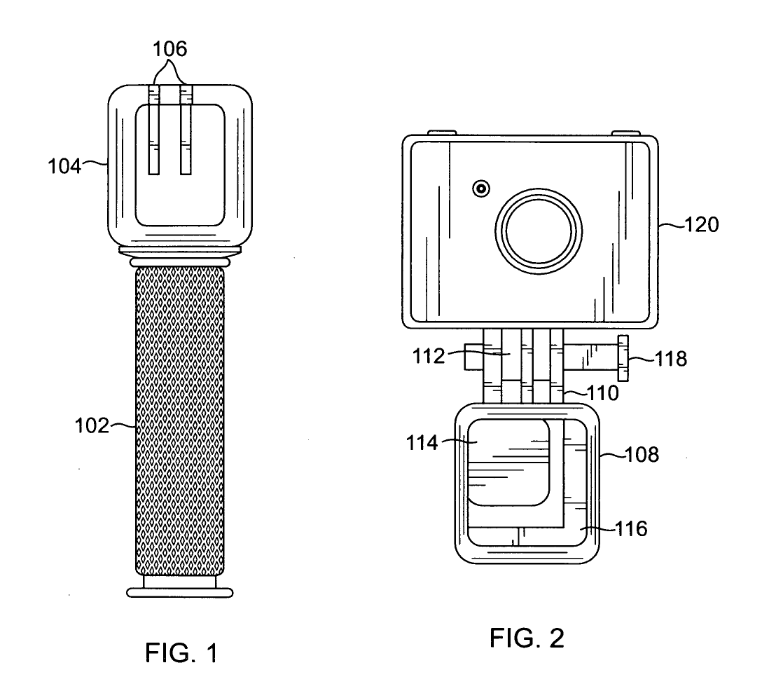

FIG. 1 shows a front view of a camera grip having a receptacle for a camera module of the present invention. Grip 102 is connected to a receptacle for camera module 104. Receptacle 104 may be part of a single piece along with grip 102, or it may be separable. Receptacle 104 includes a mechanism for locking the camera module in place 106 (camera module not shown, locking mechanism includes grooves as shown).

FIG. 2 shows a front view of a camera module of the present invention, where the module is attached to a camera. Camera module 108 includes camera mount 110, camera module back 114 and rail 116. Camera module 108, as shown, is connected to camera 120 through a pin-like mechanism 118 extending through mount 110 (three tabs as shown, but could be two or one) and camera attachment tabs 112 (two as shown).

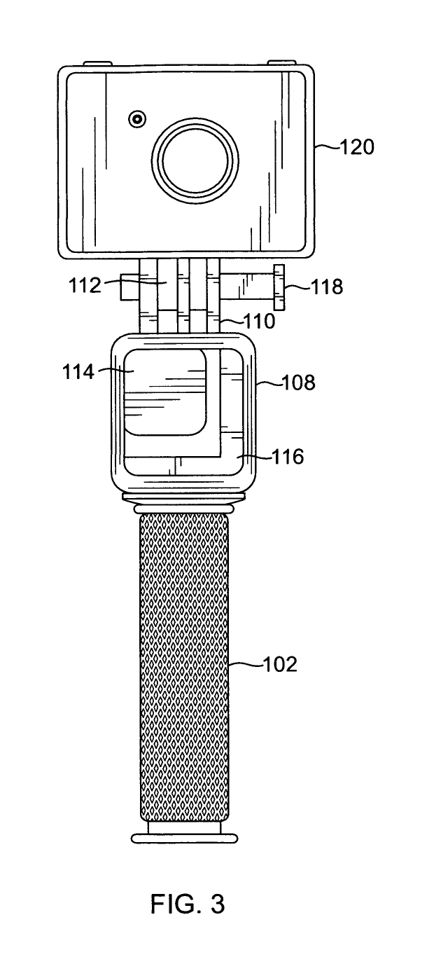

FIG. 3 shows a front view of a camera module of the present invention, where the module is attached to a camera grip and a camera. Grip 102 is attached to camera module 108 through receptacle 104 (not shown). Camera module 108 includes camera mount 110, camera module back 114 and rail 116. Camera module 108, as shown, is connected to camera 120 through a pin-like mechanism 118 extending through mount 110 (three tabs as shown, but could be two or one) and camera attachment tabs (two as shown).

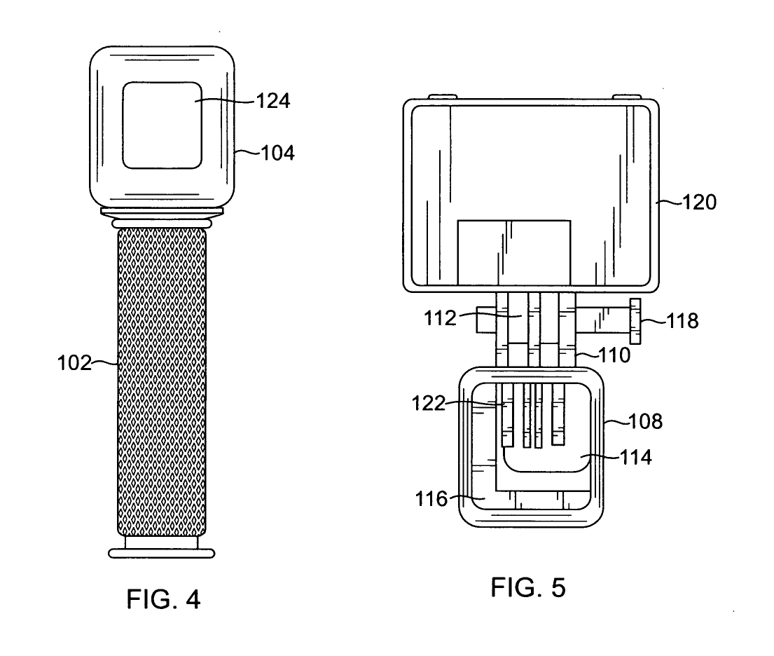

FIG. 4 shows a back view of a camera grip having a receptacle for a camera module of the present invention. Grip 102 is connected to a receptacle for camera module 104. Receptacle 104 may be part of a single piece along with grip 102, or it may be separable. Receptacle 104 includes a quick-release plate 124.

FIG. 5 shows a back view of a camera module of the present invention, where the module is attached to a camera. Camera module 108 includes camera mount 110, camera module back 114, rail 116, and camera attachment tabs 122 (for locking module 108 into receptacle 104, which is not shown). Camera module 108, as shown, is connected to camera 120 through a pin-like mechanism 118 extending through mount 110 (three tabs as shown, but could be two or one) and camera attachment tabs 112 (two as shown).

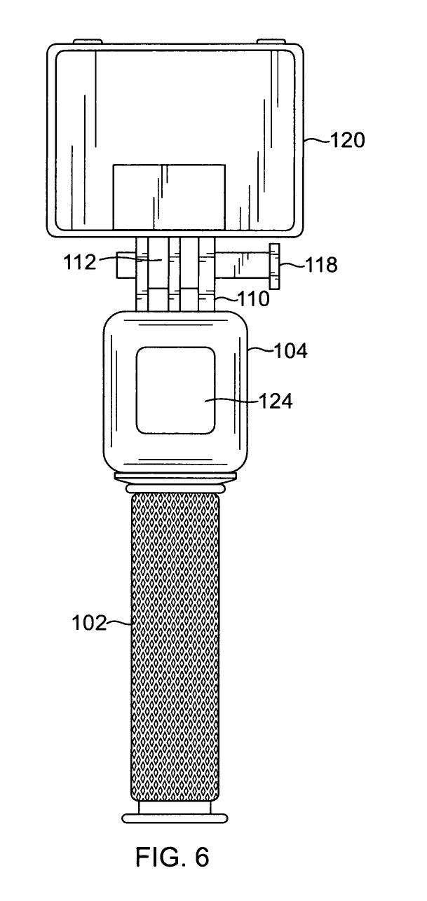

FIG. 6 shows a back view of a camera module of the present invention, where the module is attached to a camera grip and a camera. Grip 102 is connected to a receptacle for camera module 104. Receptacle 104 may be part of a single piece along with grip 102, or it may be separable. Receptacle 104 includes a quick-release plate 124. Camera mount 110 (three tabs as shown, but could be two or one) is attached to camera module 108 (not shown, but attached to receptacle 104). Camera 120 is connected to camera mount 110 through a pin-like mechanism 118 extending through mount 110 and camera attachment tabs 112 (two as shown).

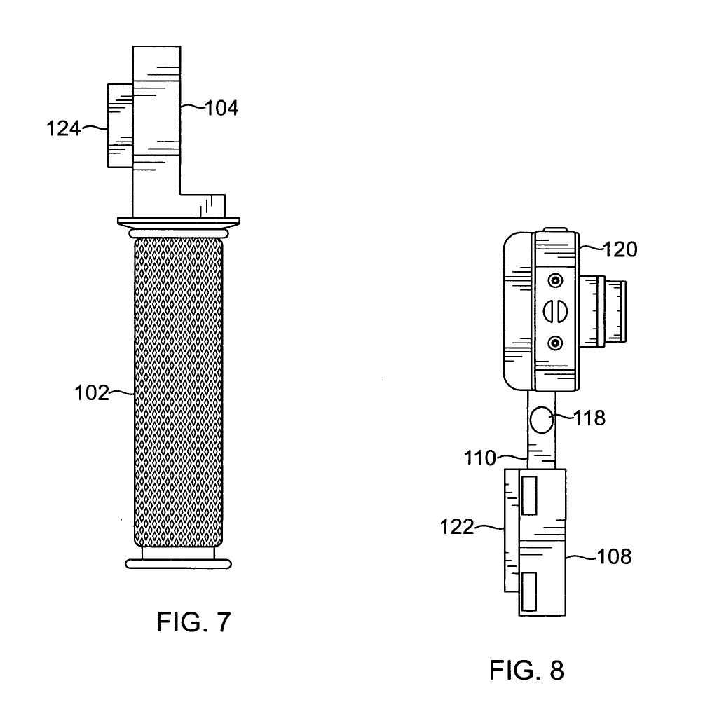

FIG. 7 shows a side view of a camera grip having a receptacle for a camera module of the present invention. Grip 102 is connected to a receptacle for camera module 104. Receptacle 104 may be part of a single piece along with grip 102, or it may be separable. Receptacle 104 includes a quick-release plate 124.

FIG. 8 shows a side view of a camera module of the present invention, where the module is attached to a camera. Camera module 108 includes camera mount 110, camera module back 114 and camera attachment tabs 122 (for locking module 108 into receptacle 104, which is not shown). Camera module 108, as shown, is connected to camera 120 through a pin-like mechanism 118 extending through mount 110 and camera attachment tabs 112 (not shown).

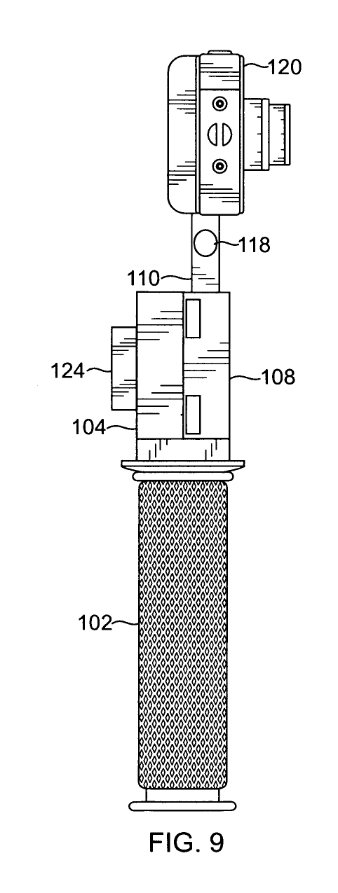

FIG. 9 shows a side view of a camera module of the present invention, where the module is attached to a camera grip and a camera. Grip 102 is connected to a receptacle for camera module 104. Receptacle 104 may be part of a single piece along with grip 102, or it may be separable. Receptacle 104 includes a quick-release plate 124. Camera module 108 is connected to receptacle 104, and it includes mount 110. Camera 120 is connected to mount 110 through a pin-like mechanism 118 extending through mount 110 and camera attachment tabs 112 (not shown).

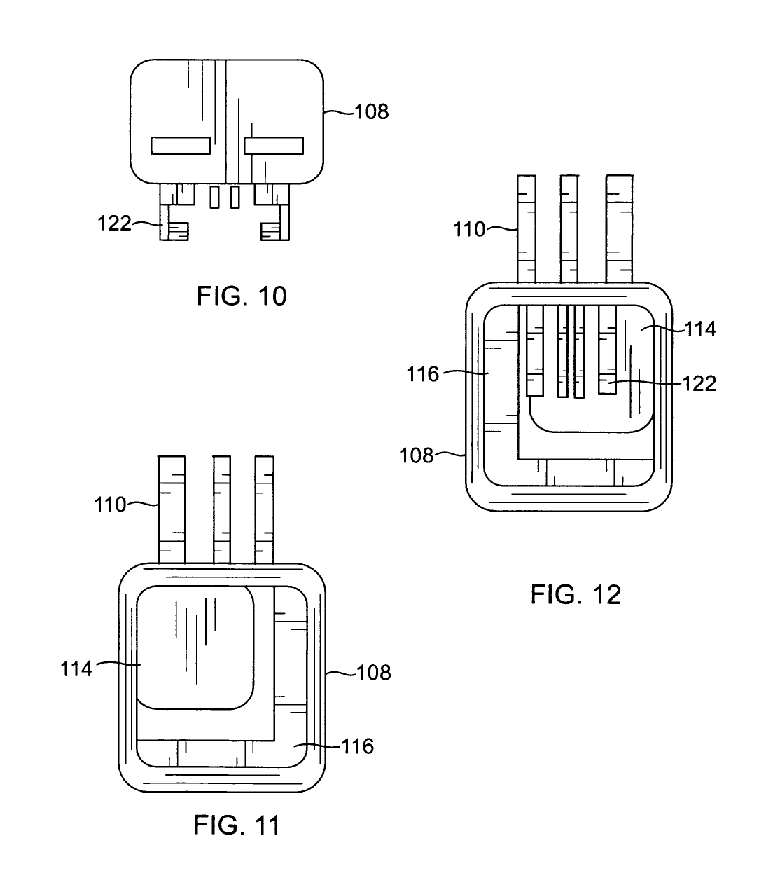

FIG. 10 shows an end view of a camera module of the present invention. Camera attachment tabs 122, which serve to lock camera module 108 onto receptacle 104 (not shown), are attached to camera module 108.

FIG. 11 shows a front view of a camera module of the present invention. Camera module 108 includes camera module back 114, rail 116 and camera mount 110. As shown, camera mount 110 has three tabs, but it could include two tabs or one.

FIG. 12 shows a back view of a camera module of the present invention. Camera module 108 includes camera module back 114—which is connected to camera attachment tabs 122—rail 116 and camera mount 110. As shown, camera mount 110 has three tabs, but it could include two tabs or one.

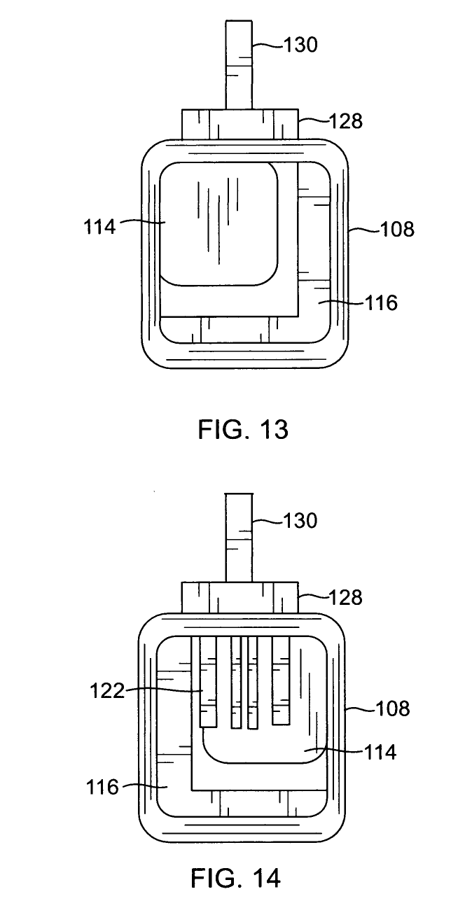

FIG. 13 shows a front view of a camera module of the present invention, where the module has a tripod screw mount. Camera module 108 includes camera module back 114, rail 116, an optional platform 128 and a camera mount 130 (a tripod screw camera mount as shown).

FIG. 14 shows a back view of a camera module of the present invention, where the module has a tripod screw mount. Camera module 108 includes camera module back 114—which is connected to camera attachment tabs 122—rail 116, an optional platform 128 and a camera mount 130 (a tripod screw camera mount as shown).

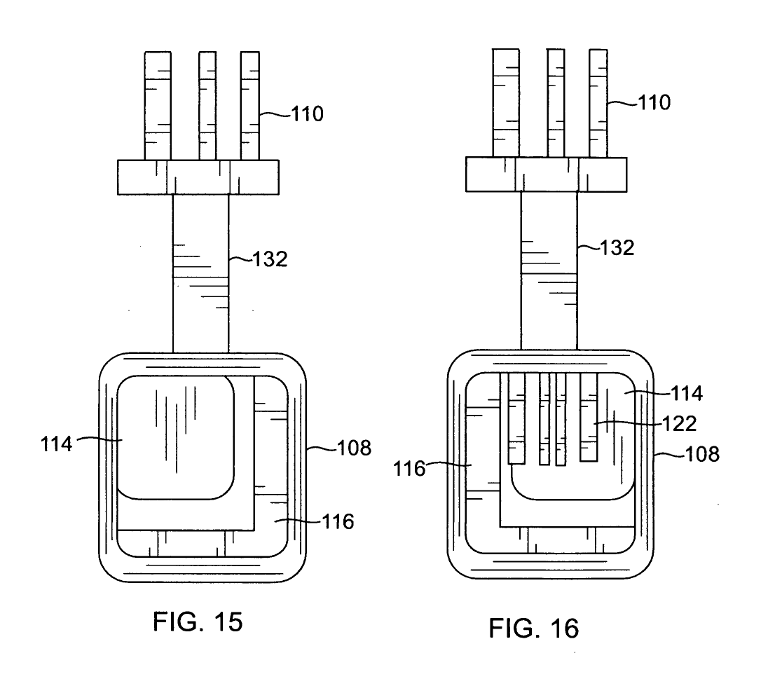

FIG. 15 shows a front view of a camera module of the present invention, where there is an extension piece between the module and the camera mount. Camera module 108 includes camera module back 114, rail 116, an extension unit 132 and camera mount 110 attached to extension unit 132. As shown, camera mount 110 has three tabs, but it could include two tabs or one. It could also be a different suitable type of mount, such as a tripod screw camera mount. As shown, extension unit 132 is a single piece, but it could consist of more than one piece—e.g., extensible unit having two or more segments.

FIG. 16 shows a back view of a camera module of the present invention, where there is an extension piece between the module and the camera mount. Camera module 108 includes camera module back 114—which is connected to camera attachment tabs 122—rail 116, an extension unit 132 and camera mount 110 attached to extension unit 132. As shown, camera mount 110 has three tabs, but it could include two tabs or one. It could also be a different suitable type of mount, such as a tripod screw camera mount. As shown, extension unit 132 is a single piece, but it could consist of more than one piece—e.g., extensible unit having two or more segments.

Camera attachment module 108 allows inclusion of various add-ons, such as screens, lights, remote controls, LCD screens, battery modules, etc. (not shown) that can aid one in the operation of a camera. The add-ons, are typically held by module 108 between camera module back 114 and rail 116.

Module 108 permits a camera user, typically a sports action camera user, to enhance the capability of his camera. For instance, where a camera either has no screen or a small screen for viewing images before or after they are captured, an LCD screen (e.g., GoPro LCD Touch BacPac) can be housed in the module. Where a camera could use extended battery life, a battery pack or rechargeable battery can be housed in the module. Where one desires to connect remote control capability with a camera, a camera remote can be housed in the module. Where one wishes to combine lighting capability with a camera, a light can be housed in the module.

The foregoing accordingly give rise to at least the following methods:

A method of increasing the effective screen size of a camera, where the method involves attaching a camera to a module that includes a second screen (typically removable) that is larger than the one on the camera itself. The module comprises a camera mount, a rail and a back, where the back includes a mechanism to connect and/or lock the module to a camera grip. The camera mount may be of any suitable configuration, but it is typically one of the following: one, two or three tabs having a through-hole through which a pin-type mechanism can be used to connect a camera to the module; a tripod screw camera mount.

A method of extending the battery life of a camera, where the method involves attaching a camera to a module that includes a battery pack and/or rechargeable battery (which are typically removable). The module comprises a camera mount, a rail and a back, where the back includes a mechanism to connect and/or lock the module to a camera grip. The camera mount may be of any suitable configuration, but it is typically one of the following: one, two or three tabs having a through-hole through which a pin-type mechanism can be used to connect a camera to the module; a tripod screw camera mount.

A method of connecting remote control capability to a camera, where the method involves attaching a camera to a module that includes a remote control (typically removable) that can operate the camera. The module comprises a camera mount, a rail and a back, where the back includes a mechanism to connect and/or lock the module to a camera grip. The camera mount may be of any suitable configuration, but it is typically one of the following: one, two or three tabs having a through-hole through which a pin-type mechanism can be used to connect a camera to the module; a tripod screw camera mount.

A method of adding lighting capability to a camera, where the method involves attaching a camera to a module that includes one or more lights (typically removable). The module comprises a camera mount, a rail and a back, where the back includes a mechanism to connect and/or lock the module to a camera grip. The camera mount may be of any suitable configuration, but it is typically one of the following: one, two or three tabs having a through-hole through which a pin-type mechanism can be used to connect a camera to the module; a tripod screw camera mount.

### LIST OF FIGURE ELEMENTS

102—Grip

104—Receptacle for camera module

106—Grooves for locking camera module

108—Camera module

110—Camera mount

112—Camera attachment tabs

114—Camera module back

116—Rail

118—Pin

120—Camera

122—Camera attachment tabs

124—Quick-release plate

126—Through-hole

128—Platform for camera mount

130—Tripod screw camera mount

132—Extension unit

1. A camera module, wherein the module comprises: a camera module back and a rail, wherein the back and rail are capable of holding a camera add-on within the module, and a camera mount, wherein camera attachment tabs allowing connection of the module to a camera grip are attached to the back.

2. The camera module according to claim 1, wherein the camera mount comprises at least one tab including a through-hole, wherein the camera mount allows camera attachment to the module using a pin-like mechanism.

3. The camera module according to claim 1, wherein the camera mount comprises a tripod screw.

4. A method of increasing the effective screen size of a camera, wherein the method comprises attaching a camera to a module that includes a second screen that is larger than the one on the camera itself, and wherein the module comprises: a camera module back and a rail, wherein the back and rail are capable of holding a camera add-on within the module, and a camera mount, wherein camera attachment tabs allowing connection of the module to a camera grip are attached to the back.

5. A method of extending the battery life of a camera, wherein the method comprises attaching a camera to a module that includes a battery pack and/or rechargeable battery, and wherein the module comprises: a camera module back and a rail, wherein the back and rail are capable of holding a camera add-on within the module, and a camera mount, wherein camera attachment tabs allowing connection of the module to a camera grip are attached to the back.

6. A method of connecting remote control capability to a camera, wherein the method comprises attaching a camera to a module that includes a remote control that can operate the camera, and wherein the module comprises: a camera module back and a rail, wherein the back and rail are capable of holding a camera add-on within the module, and a camera mount, wherein camera attachment tabs allowing connection of the module to a camera grip are attached to the back.

7. A method of adding lighting capability to a camera, where the method comprises attaching a camera to a module that includes one or more lights, and wherein the module comprises: a camera module back and a rail, wherein the back and rail are capable of holding a camera add-on within the module, and a camera mount, wherein camera attachment tabs allowing connection of the module to a camera grip are attached to the back.
